(19) United States
(12) Patent Application Publication
(10) Pub. No.: US 2026/0057585 A1
(43) Pub. Date: Feb. 26, 2026

(54) IMAGE GENERATING METHOD, APPARATUS, ELECTRONIC DEVICE AND STORAGE MEDIUM

(71) Applicant: Beijing Zitiao Network Technology Co., Ltd., Beijing (CN)

(72) Inventors: Xiwei HU, Beijing (CN); Hao XUE, Beijing (CN); Haokun CHEN, Beijing (CN); Jie SHAO, Beijing (CN)

(21) Appl. No.: 19/306,326

(22) Filed: Aug. 21, 2025

(30) Foreign Application Priority Data
Aug. 21, 2024 (CN) 202411155324.2

(51) Int. Cl. G06T 11/60; G06F 40/30

(52) U.S. Cl. CPC G06T 11/60; G06F 40/30

(57) ABSTRACT

The present disclosure relates to an image generating method and apparatus, an electronic device, and an storage medium, the method includes: obtaining a target text, the target text including description information of background image and text to be displayed; determining the text to be displayed based on the target text; generating a first image based on the target text; compositing the text to be displayed with the first image to obtain a target image, and the target image includes the text to be displayed.

The present application claims the priority of the Chinese Patent Application No. 202411155324.2 filed on Aug. 21, 2024, the entire contents disclosed by the Chinese patent application are hereby incorporated by reference as a part of the present application.

### TECHNICAL FIELD

The present disclosure relates to the technical field of the artificial intelligence, and more particularly to an image generating method and apparatus, an electronic device, and a storage medium.

### BACKGROUND

In the digital age, image generation technology, as an important breakthrough in the field of artificial intelligence, has greatly enriched user's content creation experience and brought unprecedented innovation power to many industries. However, the image generation technology still has certain limitations and cannot fully meet the needs of all image generation scenarios. For example, when a user wants to include specific characters in the generated image, the existing image generation model cannot accurately embody these characters in the generated image, resulting in unsatisfactory character display effect.

### SUMMARY

In order to solve the above-described technical problems or at least partially solve the above-described technical problems, the present disclosure provides an image generating method and apparatus, an electronic device, and a storage medium.

In a first aspect, the present disclosure provides an image generating method, which includes:
obtaining a target text; the target text including description information of a background image and a text to be displayed;
determining the text to be displayed based on the target text;
generating a first image based on the target text; and
compositing the text to be displayed with the first image to obtain a target image, and the target image including the text to be displayed.

In a second aspect, the present disclosure further provides an image generating method, comprising:
obtaining module, for obtaining target text; the target text includes description information of a background image and text to be displayed; a determining module configured to determine text to be displayed based on the target text;
generating module for generating a first image based on the target text;
compositing module for compositing the text to be displayed with the first image to obtain a target image, the target image including the text to be displayed.

In a third aspect, the present disclosure further provides an electronic device, the electronic device comprising:
one or more processor;
storage apparatus for storing one or more programs;
when the one or more programs are executed by the one or more processor such that the one or more processor implements the image generating method as described above.

In a fourth aspect, the present disclosure also provides a computer-readable storage medium having computer program stored thereon, and when the program is executed by the processor, the image generating method as described above is realized.

### BRIEF DESCRIPTION OF DRAWINGS

The accompanying drawings herein, which are incorporated into and constitute a part of the specification, illustrate embodiments consistent with the present disclosure and, together with the specification, serve to explain the principles of the present disclosure.

In order to more clearly explain the technical solutions in the embodiments of the present disclosure or the prior art, the drawings that need to be used in the description of the embodiments or the existing art will be briefly introduced below, and it is obvious that other drawings can be obtained from these drawings without making creative labor for those skilled in the art.

FIG. 1 is a flowchart of an image generating method according to an embodiment of the present disclosure.

FIG. 2 is a schematic diagram of a first image according to an embodiment of the present disclosure.

FIG. 3 is a schematic diagram of a target image according to an embodiment of the present disclosure.

FIG. 4 is a schematic structural diagram of an image generating apparatus according to an embodiment of the present disclosure.

FIG. 5 is a schematic structural diagram of an electronic device according to an embodiment of the present disclosure.

### DETAILED DESCRIPTION

In order to enable a clearer understanding of the above-described objects, features, and advantages of the present disclosure, aspects of the present disclosure will be further described below. It is to be noted that the embodiments of the present disclosure and the features in the embodiments may be combined with each other without conflict.

Numerous specific details are set forth in the following description to facilitate a full understanding of the present disclosure, but the present disclosure may be practiced in other ways than those described herein. Obviously, the embodiments in the specification are only some embodiments of the present disclosure, but not all embodiments.

FIG. 1 is a flowchart of an image generating method provided by an embodiment of the present disclosure, the present embodiment can be applied to a case where image is generated in a client, and the method can be executed by an image generating apparatus, which can be implemented by software and/or hardware, and can be configured in an electronic device, such as a terminal, specifically including but not limited to a smartphone, a handheld computer, a tablet computer, a wearable device with a display screen, a desktop computer, a notebook computer, an all-in-one computer, a smart home device, and the like. Alternatively, the present embodiment may be applied to a case where image generation is performed in a server, and the method may be performed by an image generating apparatus, which may be implemented in software and/or hardware, and which may be configured in an electronic device, such as a server.

As illustrated by FIG. 1, the method may specifically include:

S110: obtaining a target text; target text includes description information of a background image and a text to be displayed.

The target text may be, for example, text input by a user. Subsequently, the target text can be directly used as a prompt for an image generation model and input to the image generation model, and then the image generation model generates an image.

In the present application, the ultimate desired image is a target image. The target image includes a background image and text information (which may also be referred to as text) superimposed on the background image. The description information of the background image in the target text is used to guide image generation model to generate the background image, and the generated background image is the first image mentioned later. The text to be displayed in target text is the text information that the user wants to superimpose on the background image.

In practice, the present application does not limit the order of the description information of the background image and the text to be displayed presented in the target text.

Exemplarily, assuming that target text is “There is a person playing frisbee on the grass with a puppy with the words ‘Happy Hour on the grass’ written on it”, in which the “There is a person playing frisbee on the grass with a puppy” is the description information of the background image, and the “Happy Hour on the Grass” is the text to be displayed.

S120: determining the text to be displayed based on the target text.

Although target text includes the text to be display, electronic device does not “know” which character or characters belong to the text to be display. The essence of this step is to parse the target text so that electronic device knows which character or characters belong to the text to be displayed.

There are many ways to implement this step, and the present application is not limited thereto. Exemplarily, the implementation method of the present step includes: performing semantic analysis on the target text to obtain a semantic analysis result; and obtaining the text to be displayed based on the semantic analysis results.

The semantic analysis on the target text can be realized by using a model with semantic analysis function. The model with semantic analysis function can comprehensively and deeply analyze the target text, clarify the meaning of the target text as a whole and the meaning of each word, and analyze the relationship between entities in the target text. Through semantic analysis of the target text, the electronic device can understand which character or characters in the target text users want as the text to be displayed, thereby improving the accuracy of determining the text to be displayed.

Further, the target text may be configured to include a location identifier for indicating a location of the text to be displayed in the target text. The obtaining the text to be displayed based on the semantic analysis result may include: determining the text to be displayed in target text based on the semantic analysis result and the location identifier.

The location identifier may be specified in advance, for example, and when the user inputs the target text, the user may be guided to use the location identifier by means of prompt information. The present application does not limit the specific type of identifier that the location identifier is. For example, the location identifier is a specific punctuation mark, such as “ ”. Alternatively, the location identifier is a specific phrase or phrase, such as words . . . written on it.

For example, if the target text is “There is a person playing frisbee on the grass with a puppy with the words ‘Happy Hour on the Grass’ written on it”, the location identifier is “. Based on the location identifier, “Happy hour on the grass”_9 can be obtained as the text to be displayed.

Optionally, the determining the text to be displayed in target text based on the semantic analysis result and the location identifier may include: performing semantic analysis on the target text to obtain a first text and a confidence level of the first text; determining a second text in the target text based on the location identifier, and determining a confidence level of the second text. According to the confidence level of the first text and the confidence level of the second text, the text to be displayed is determined among the first text and the second text. The first text and the second text are determined in the target text based on different methods, possibly as characters or character string of the text to be displayed. Optionally, if the confidence level of the first text is higher than the confidence level of the second text, it is determined that the first text is a text to be displayed. If the confidence level of the second text is higher than the confidence level of the first text, the second text is determined as the text to be displayed. This arrangement can make the obtained text to be displayed more accurate.

S130: generating a first image based on the target text.

There are many ways to implement this step, and this step is not limited thereto. Exemplarily, a method of implementing this step may include inputting the target text into an image generating module (such as a text-to-image model or an image-to-image model) to cause image generation model to generate the first image.

S140: compositing the text to be displayed with the first image to obtain a target image, and the target image includes the text to be displayed.

There are many ways to implement this step, and the present application is not limited thereto. Exemplarily, the text to be displayed may be superimposed on top of the first image as a top-level element to obtain the target image.

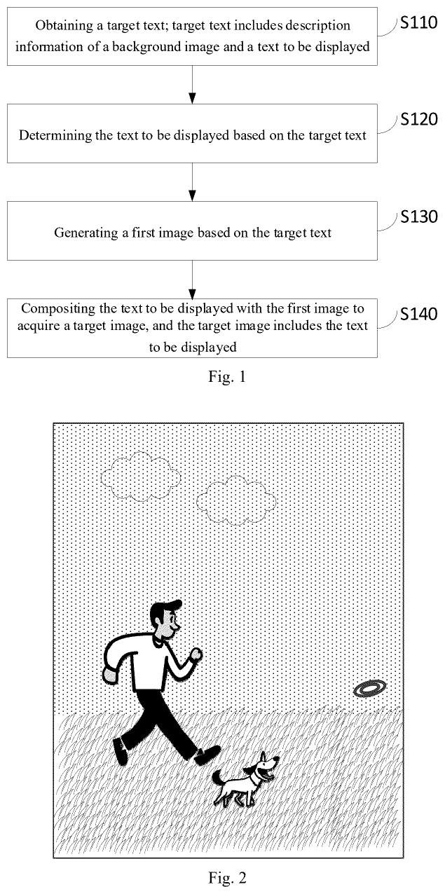

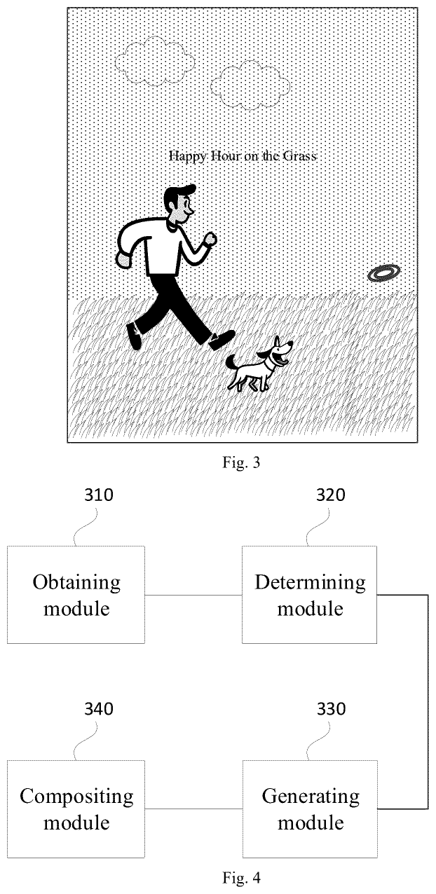

For example, assuming that the target text is “There is a person playing frisbee on the grass with a puppy with the words ‘Happy Hour on the Grass’ written on it”, based on this target text, the text to be displayed can be “Happy Hour on the Grass”. The first image generated based on the target text is illustrated by FIG. 2, and the “Happy Hour on the Grass” is composited with the first image to obtain the target image. The obtained target image is shown in FIG. 3. In the target image, “Happy times on the grass” are embodied in the form of words.

Because the working principle of the existing image generation model, especially diffusion model, usually involves stepwise denoising processing of the initial stochastic noise image to the final generated image, although these models can understand and reflect the provided prompt information to some extent, in actual operation, due to the complexity and uncertainty of the models, they cannot well reflect the text to be displayed in the form of words in the generated image.

The above technical solution is configured for: obtaining a target text, the target text includes description information of a background image and text to be displayed; determining the text to be displayed based on the target text; generating a first image based on the target text; and compositing the text to be displayed with the first image to obtain a target image, and the target image includes the text to be displayed. Its essence is to give a method that can contain specific characters in the generated image, which can meet the diverse image generation requirement of users. The above technical solution can be applied to a scene in which a wallpaper, a poster, or the like is created.

It should also be emphasized that when the target text explicitly includes the characters that need to be reflected in the image, the characters that need to be reflected are directly extracted from the target text, and the characters that need to be reflected are directly superimposed on the generated image, which can ensure that the characters reflected in the target image are consistent with the characters to be displayed included in the target text. In other words, the characters included in the target image generated by adopting the technical solution provided in the present application are specified by the user and are in accordance with the needs of the user, and are not randomly generated.

In the above technical solution, S140 may include: determining a rendering scheme corresponding to the text to be displayed; rendering the text to be displayed based on the rendering scheme corresponding to the text to be displayed; compositing the text to be displayed after rendering with the first image to get target image.

The rendering scheme corresponding to the text to be displayed may be, for example, a rendering scheme suitable for the text to be displayed, and may specifically include one or more aspects such as a display font of the text to be displayed, a display size of the text to be displayed, a display position of the text to be displayed, and a display color of the text to be displayed.

There are many specific implementation methods of “determining the rendering scheme corresponding to the text to be displayed”, and the present disclosure is not limited thereto. In practice, the rendering scheme corresponding to the text to be displayed may be determined by interacting with the user. For example, if the rendering scheme includes a display position of the target text, determining the rendering scheme corresponding to the text to be displayed may include: displaying the first image and an area selection tool, and the area selection tool is used to assist the user in selecting a display position of the text to be displayed in the first image; in response to the use operation of the area selection tool, the area indicated by the area selection tool is set as a display position corresponding to the text to be displayed.

If the rendering scheme includes one or more of the display font of the text to be displayed, a display size of the text to be displayed, and a display color of the text to be displayed, determining the rendering scheme corresponding to the text to be displayed may include: displaying an option related to the rendering scheme, and at least one of the display font, the display size, and the display color corresponding to the option is different; in response to the selection operation of one of the options related to the rendering scheme, the rendering scheme corresponding to the selected option is taken as the rendering scheme corresponding to the text to be presented.

In some scenarios, the target text may include the user's requirements for specific rendering schemes for the text to be displayed. In view of such a situation, for example, “determining the rendering scheme corresponding to the text to be displayed” may include: performing semantic analysis on the target text to obtain a semantic analysis result; and obtaining the rendering scheme corresponding to the text to be displayed based on the semantic analysis results.

Illustratively, the target text is “There is a person playing frisbee on the grass with a puppy, and the words ‘Happy Hour on the Grass’ are written in the sky”. In this example, the display location of “Happy Hour on the Grass” (i.e., text to be displayed) is defined in the target text, i.e., in the sky. Through semantic analysis of target text, it can be obtained that the user wants to display the text to be displayed in the sky.

Further, in order to enable the text to be displayed to be appropriately displayed in the target image so that the text to be displayed can be better integrated with the background image in the target image, a rendering scheme corresponding to the text to be displayed may be obtained based on the semantic analysis result, which includes: determining the image scheme corresponding to the text to be displayed based on the semantic analysis result and feature information of the first image; the feature information of the first image includes at least one of a size of the first image, a color of the first image, and a content of the first image.

Exemplarily, the size of the text to be displayed may be determined according to the size of the first image. For example, according to the size of the first image, the maximum size limit and the minimum size limit of the text to be displayed are determined to ensure that the size of the text to be displayed is larger than the minimum size limit and smaller than the size of the first image. In this way, there is no case that the user cannot quickly observe the text to be displayed because the size of the text to be displayed is too small, and there is no case that the size of the text to be displayed is too large and the display in the first image is incomplete.

The content of the first image may include information such as a position occupied by the object in the first image. The object in the first image may be, for example, an object in the first image, such as a person, an animal, a plant, a building, an object, a sky, a ground, or the like. Exemplarily, it is set that the text to be displayed does not overlap with the main object in the first image. The main object may be, for example, an object that needs to be focused on or is desired to be highlighted in the first image. Exemplarily, the main object may be, for example, a person, an animal, a plant, a building or an object, or the like. The number of main object may be one or more. The purpose of setting the text to be displayed not to overlap with the main object in the first image is that the target text does not block the main object in the first image.

The color of the first image may be, for example, the main color of the first image, and/or the color of a local area in the first image.

Optionally, the display color of the text to be displayed may be determined based on the color of the first image. On the one hand, this arrangement is to make the color tone of the text to be displayed after the rendering similar to the overall color tone of the first image, so that the text to be displayed can be naturally and unabruptly integrated into the first image. On the other hand, this arrangement is to make the color of the text to be displayed after the rendering be different from the color of the image at the display position of the text to be displayed in the first image, so that the first image and the text to be displayed can be distinguished in color, and the text to be displayed can be easily observed. This can not only maintain the overall visual coordination, but also ensure the high readability and prominence of the text.

Further, a color referring area can be determined in the first image, and the display color of the target text can be determined according to the average value of colors of the pixels in the color referring area. Alternatively, the entire picture of the first image may be used as the color referring area, or the color referring area can be determined by taking a center of the display area of the first image as a center point and a preset distance as a radius.

Optionally, if the display color of the text to be displayed is determined based on the color of a local area in the first image, the color referring area can be determined by taking the display position of the first image as a center point and a preset distance as the radius, and the display color of the text to be displayed may be determined based on the color of the color referring area.

On the basis of the above technical solution, optionally, the method may further include: recognizing a character in the target image to obtain a first character recognition result; in response to the first character recognition result being consistent with the text to be displayed, the target image is output.

In practice, the target text is directly used as prompt information, and the first image generated may also include characters, but the characters are different from the text to be displayed. By recognizing the characters in the target image to obtain the first character recognition result; in response to the first character recognition result being consistent with the text to be displayed; the target image is output, and the purpose is to strictly control target image, so as to filter out target image where the included characters are different from the text to be displayed, so as to improve the image generation experience under the specific needs of users.

It can be understood that before using the technical solutions disclosed in each embodiment of the present disclosure, users should be informed of the types, usage scope, usage scenarios, etc. of the personal information involved in the present disclosure in an appropriate manner in accordance with relevant laws and regulations, and authorization from the users should be obtained.

For example, in response to receiving an active request from the user, prompt information is sent to the user to explicitly prompt the user that the operation it requests to perform will require the acquisition and use of the user's personal information. Accordingly, the user can autonomously select whether or not to provide personal information to software or hardware such as an electronic device, an application, a server, or a storage medium that performs the operation of the technical solution of the present disclosure according to prompt information.

As an optional but non-limiting implementation, in response to receiving an active request from the user, the manner of sending prompt information to the user may be, for example, the manner of a pop-up window, and the pop-up window may be presented in text in the prompt information. In addition, the pop-up window can also carry an optional control for users to choose “agree” or “disagree” to provide personal information to the electronic device.

It is to be understood that the above-described procedures of notifying and obtaining user authorization are merely illustrative and do not limit the implementation forms of the present disclosure, and other methods satisfying relevant laws and regulations can also be applied to the implementation forms of the present disclosure.

It should be noted that the above-described method embodiments are described as a series of combinations of operations for simplicity of description, but those skilled in the art should recognize that the present disclosure is not limited by the described sequence of operations, because according to the present invention, some steps may be performed in other sequences or simultaneously. Secondly, those skilled in the art should also understand that the embodiments described in the specification are preferred embodiments, and the acts and modules involved are not necessarily necessary for the present invention.

FIG. 4 is a schematic structural diagram of an image generating apparatus according to an embodiment of the present disclosure. The image generating apparatus provided by the embodiment of the present disclosure may be configured in a client or may be configured in a server. Referring to FIG. 4, the image generating apparatus specifically includes:
an obtaining module 310, configured for obtaining a target text; the target text includes description information of a background image and text to be displayed;
a determining module 320, configured for determining the text to be displayed based on the target text;
a generating module 330, configured for generating a first image based on the target text;
a compositing module 340, configured for compositing the text to be displayed with the first image to obtain a target image, and the target image includes the text to be displayed.

Further, the determining module 320 is configured for:
performing semantic analysis on the target text to obtain a semantic analysis result; and
obtaining the text to be displayed based on the semantic analysis result.

Further, the target text includes a location identifier, and the location identifier is used to indicate a location of the text to be displayed in the target text, and the determining module 320 is configured for:
determining the text to be displayed in the target text based on the semantic analysis result and the location identifier.

Further, the compositing module 340 is configured for:
determining a rendering scheme corresponding to the text to be displayed; the rendering scheme includes at least one of a display font of the text to be displayed, a display size of the text to be displayed, a display location of the text to be displayed, and a display color of the text to be displayed;
rendering the text to be displayed based on the rendering scheme corresponding to the text to be displayed; and
compositing the text to be displayed after rendering with the first image to obtain the target image.

Further, the compositing module 340 is configured for:
performing semantic analysis on the target text to obtain a semantic analysis result;
obtaining a rendering scheme corresponding to the text to be displayed based on the semantic analysis result.

Further, the compositing module 340 is configured for:
determining the rendering scheme corresponding to the text to be displayed based on the semantic analysis result and the feature information of the first image; the feature information of the first image includes at least one of a size of the first image, a color of the first image, and a content of the first image.

Further, the apparatus further includes an output module, configured for:
recognizing characters in the target image to obtain a first character recognition result;
outputting the target image in response to the first character recognition result being consistent with the text to be displayed.

The image generating apparatus provided by the embodiment of the present disclosure can execute the steps executed by client or server in the image generating method provided by the embodiment of the method of the present disclosure, and has execution steps and beneficial effects, and will not be repeatedly described herein.

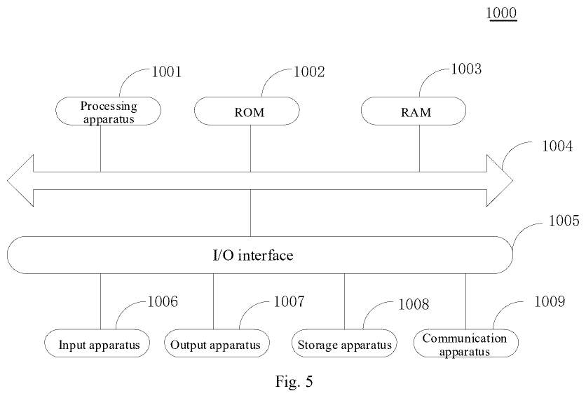

FIG. 5 is a schematic structural diagram of an electronic device according to an embodiment of the present disclosure. 5, which shows a structural schematic diagram suitable for implementing an electronic device 1000 in an embodiment of the present disclosure, is specifically referring to. The electronic device 1000 in the embodiment of the present disclosure may include, but is not limited to, an electronic device such as a mobile phone, a notebook computer, a digital broadcast receiver, a PDA (personal digital assistant), a PAD (Tablet PC), a PMP (Portable Multimedia Player), an in-vehicle terminal (for example, an in-vehicle navigation terminal), a wearable mobile terminal, and the like, and a fixed terminal such as a digital TV, a desktop computer, a smart home device, and the like. The electronic device illustrated in FIG. 5 is merely an example, and should not impose any limitation on the functionality and scope of use of the embodiments of the present disclosure.

As illustrated by FIG. 5, the electronic device 1000 may include a processing apparatus (e.g., central processing unit, graphics processing unit, etc.) 1001 that may perform various appropriate actions and processes in accordance with a program stored in the read-only memory (ROM) 1002 or a program loaded from the storage apparatus 1008 into the random access memory (RAM) 1003 to achieve the image generating method of embodiments as described in the present disclosure. In the RAM 1003, various programs and information necessary for the operation of the electronic device 1000 are also stored. The processing apparatus 1001, the ROM 1002, and the RAM 1003 are connected to each other by a bus 1004. An input/output (I/O) interface 1005 is also connected to the bus 1004.

Generally, the following apparatuses may be connected to the I/O interface 1005: an input apparatus 1006 including, for example, a touchscreen, a keyboard, a mouse, a camera, a microphone, an accelerometer, a gyroscope, etc. ; an output apparatus 1007 including, for example, a liquid crystal display (LCD), a speaker, a vibrator, and the like; a storage apparatus 1008 including, for example, a magnetic tape, a hard disk, etc. ; and a communication apparatus 1009. The communication apparatus 1009 may allow the electronic device 1000 to communicate wirelessly or wired with other devices to exchange information. Although FIG. 5 shows an electronic device 1000 with various apparatuses, it should be understood that it is not required that all of the apparatuses shown be implemented or provided. More or fewer apparatuses may alternatively be implemented or provided.

In particular, according to the embodiments of the present disclosure, the processes described above with reference to the flowcharts can be implemented as a computer software program. For example, the embodiments of the present disclosure include a computer program product, which comprises a computer program carried on a non-transitory computer-readable medium. The computer program contains program code for performing the methods shown in the flowcharts, thereby implementing the image generation method as described above. In such embodiments, the computer program can be downloaded and installed from a network via the communication apparatus 1009, or installed from the storage apparatus 1008, or installed from the ROM 1002. When the computer program is executed by the processing apparatus 1001, the functions defined in the methods of the present disclosure as described above are performed.

It should be noted that the computer-readable medium mentioned above in the present disclosure can be a computer-readable signal medium or a computer-readable storage medium, or any combination of the two. A computer-readable storage medium can be, for example, but not limited to, an electronic, magnetic, optical, electromagnetic, infrared, or semiconductor system, device, or component, or any combination of the above. More specific examples of computer-readable storage media can include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium that contains or stores a program that can be used by or in connection with an instruction execution system, device, or component. In the present disclosure, a computer-readable signal medium can include an information signal propagated in a baseband or as part of a carrier wave, which carries computer-readable program code. This propagated information signal can take various forms, including but not limited to electromagnetic signals, optical signals, or any suitable combination of the above. A computer-readable signal medium can also be any computer-readable medium other than a computer-readable storage medium, which can send, propagate, or transmit a program for use by or in connection with an instruction execution system, device, or component. Program code contained on a computer-readable medium can be transmitted using any appropriate medium, including but not limited to: wires, optical fibers, RF (radio frequency), etc., or any suitable combination of the above.

In some embodiments, the client and server can communicate using any known or future-developed network protocol, such as HTTP (HyperText Transfer Protocol), and can be interconnected with digital information communication in any form or medium (e.g., communication networks). Examples of communication networks include local area networks (“LAN”), wide area networks (“WAN”), internetworks (e.g., the Internet), and peer-to-peer networks (e.g., ad hoc peer-to-peer networks), as well as any known or future-developed networks.

The computer-readable medium may be included in the electronic device described above; it may also exist alone without being fitted into the electronic device.

The computer-readable medium carries one or more programs that, when executed by the electronic device, the electronic device is configured for:
obtaining a target text; the target text includes description information of a background image and text to be displayed;
determining the text to be displayed based on the target text;
generating a first image based on the target text;
compositing the text to be displayed with the first image to obtain a target image, and the target image includes the text to be displayed.

Optionally, when the one or more programs are executed by the electronic device, the electronic device may also execute other steps described in the above embodiments.

The computer program code for performing the operations of the present disclosure may be written in one or more programming languages or combinations thereof. The programming languages include, but are not limited to, object-oriented programming languages—such as Java, Smalltalk, C++—and also include conventional procedural programming languages—such as the “C” language or similar programming languages. The program code can be executed entirely on the user's computer, partly on the user's computer, as a stand-alone software package, partly on the user's computer and partly on a remote computer, or entirely on a remote computer or server. In the context of involving a remote computer, the remote computer can be connected to the user's computer through any type of network, including a local area network (LAN) or a wide area network (WAN), or it can be connected to an external computer (for example, using an Internet service provider to connect through the Internet).

Flowcharts and block diagrams in the drawings illustrate the architecture, functionality, and operation of possible implementations of systems, methods, and computer program product in accordance with various embodiments of the present disclosure. In this regard, each block in the flowchart or block diagram may represent a module, program segment, or portion of code that contains one or more executable instructions for implementing a specified logical function. It should also be noted that, in some alternative implementations, the functions noted in the blocks may also occur in a different order than that noted in the figures. For example, two blocks represented in succession may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or operations, or may be implemented with a combination of dedicated hardware and computer instructions.

The units described in the embodiments of the present disclosure may be implemented by software or hardware. Here, the name of the unit does not constitute a limitation of the unit itself in some cases.

The functions described above herein may be performed, at least in part, by one or more hardware logic components. For example, and without limitation, exemplary types of hardware logic components that may be used include Field Programmable Gate Arrays (FPGAs), Application Specific Integrated Circuits (ASICs), Application Specific Standard Products (ASSPs), Systems on tile (SOCs), Complex Programmable Logic Devices (CPLDs), and the like.

In the context of the present disclosure, the machine-readable medium may be a tangible medium that may contain or store a program for use by or in conjunction with an instruction execution system, apparatus, or device. The machine readable medium may be a machine readable signal medium or a machine readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage medium may include one or more wire-based electrical connections, portable computer disks, hard disk, random access memory (RAM), read-only memory (ROM), erasable programmable read-only memory (EPROM or Flash memory), optical fiber, handy compact disk read-only memory (CD-ROM), optical storage devices, magnetic storage devices, or any suitable combination of the foregoing.

According to one or more embodiments of the present disclosure, the present disclosure provides an electronic device comprising:
one or more processor;
a memory for storing one or more programs;
when the one or more programs are executed by the one or more processor, the one or more processor implements the image generating method as provided in any one of the present disclosure.

According to one or more embodiments of the present disclosure, the present disclosure provides a computer-readable storage medium having computer program stored thereon, and when executed by a processor, the program realizes the image generating method as described in any one of the present disclosures.

Embodiments of the present disclosure also provide a computer program product, the computer program product including computer program or instructions, and when executed by computer program, the processor or instructions achieve the image generating method as described above.

It should be noted that, herein, relational terms such as “first” and “second” are used merely to distinguish one entity or operation from another entity or operation, and do not necessarily require or imply any such actual relationship or order between the entities or operations. Moreover, the terms “comprising,” “including,” or any other variation thereof are intended to encompass a non-exclusive inclusion such that a process, method, article, or apparatus that includes a series of elements includes not only those elements, but also other elements that are not explicitly listed, or elements inherent to such a process, method, article, or apparatus. Without further limitation, an element defined by the statement “comprising a” does not preclude the presence of additional identical elements in a process, method, article, or apparatus comprising the element.

The foregoing is merely a specific embodiment of the present disclosure to enable those skilled in the art to understand or implement the present disclosure. Various modifications to these embodiments will be apparent to those skilled in the art, and the general principles defined herein may be implemented in other embodiments without departing from the spirit or scope of the present disclosure. Accordingly, the present disclosure is not to be limited to the embodiments described herein, but is to be accorded the widest scope consistent with the principles and novel features disclosed herein.

1. An image generating method comprising:
obtaining a target text; the target text comprising description information of a background image and a text to be displayed;
determining the text to be displayed based on the target text;
generating a first image based on the target text; and
compositing the text to be displayed with the first image to obtain a target image, and the target image comprising the text to be displayed.

2. The image generating method according to claim 1, wherein the determining the text to be displayed based on the target text comprises:
performing semantic analysis on the target text to obtain a semantic analysis result; and
obtaining the text to be displayed based on the semantic analysis result.

3. The image generating method according to claim 2, wherein the performing semantic analysis on the target text to obtain a semantic analysis result comprises:
analyzing the target text;
clarifying a meaning of the target text as a whole and a meaning of each word in the target text; and
analyzing a relationship between entities in target text.

4. The image generating method according to claim 2, wherein the target text comprises a location identifier for indicating a location of the text to be displayed in the target text, and the obtaining the text to be displayed based on the semantic analysis result comprises:
determining the text to be displayed in the target text based on the semantic analysis result and the location identifier.

5. The image generating method according to claim 4, wherein the compositing the text to be displayed with the first image to obtain the target image comprises:
determining a rendering scheme corresponding to the text to be displayed; the rendering scheme comprising at least one of a display font of the text to be displayed, a display size of the text to be displayed, a display position of the text to be displayed, and a display color of the text to be displayed;
rendering the text to be displayed based on the rendering scheme corresponding to the text to be displayed; and
compositing the text to be displayed after rendering with the first image to obtain the target image.

6. The image generating method according to claim 4, wherein the performing semantic analysis on the target text to obtain a semantic analysis result comprises:
performing semantic understanding on the target text to obtain e a first text and a confidence level of the first text; and
determining a second text in the target text based on the location identifier, and determining a confidence level of the second text.

7. The image generating method according to claim 6, wherein the determining the text to be displayed in the target text based on the semantic analysis result and the location identifier comprises:
determining the text to be displayed among the first text and the second text according to the confidence level of the first text and the confidence level of the second text,
wherein in response to the confidence level of the first text being higher than the confidence level of the second text, the first text is determined as the text to be displayed; in response to the confidence level of the second text being higher than the confidence level of the first text, the second text is determined as the text to be displayed.

8. The image generating method according to claim 1, wherein the determining the rendering scheme corresponding to the text to be displayed comprises:
performing semantic analysis on the target text to obtain a semantic analysis result; and
obtaining the rendering scheme corresponding to the text to be displayed based on the semantic analysis result.

9. The image generating method according to claim 8, wherein the obtaining the rendering scheme corresponding to the text to be displayed based on the semantic analysis result comprises:
determining the rendering scheme corresponding to the text to be displayed based on the semantic analysis result and feature information of the first image; wherein the feature information of the first image comprises at least one of a size of the first image, a color of the first image, and a content of the first image.

10. The image generating method according to claim 1, further comprising:
recognizing characters in the target image to obtain a first character recognition result;
outputting the target image in response to the first character recognition result being consistent with the text to be displayed.

11. An electronic device comprising:
one or more processor; and
a non-transitory storage apparatus with instructions thereon;
wherein the instructions upon execution by the processor, cause the processor to perform an image generating method, and the method comprises:
acquiring a target text; the target text comprising description information of a background image and a text to be displayed;
determining the text to be displayed based on the target text;
generating a first image based on the target text; and
synthesizing the text to be displayed with the first image to acquire a target image, and the target image comprising the text to be displayed.

12. The electronic device according to claim 9, wherein the determining the text to be displayed based on the target text comprises:
performing semantic analysis on the target text to obtain a semantic analysis result; and
obtaining the text to be displayed based on the semantic analysis result.

13. The electronic device according to claim 12, wherein the target text comprises a location identifier for indicating a location of the text to be displayed in the target text, and the obtaining the text to be displayed based on the semantic analysis result comprises:
determining the text to be displayed in the target text based on the semantic analysis result and the location identifier.

14. The electronic device according to claim 13, wherein the compositing the text to be displayed with the first image to obtain the target image comprises:
determining a rendering scheme corresponding to the text to be displayed; the rendering scheme comprising at least one of a display font of the text to be displayed, a display size of the text to be displayed, a display position of the text to be displayed, and a display color of the text to be displayed;
rendering the text to be displayed based on the rendering scheme corresponding to the text to be displayed; and
compositing the text to be displayed after rendering with the first image to obtain the target image.

15. The electronic device according to claim 13, wherein the performing semantic analysis on the target text to obtain a semantic analysis result comprises:
performing semantic understanding on the target text to obtain e a first text and a confidence level of the first text; and
determining a second text in the target text based on the location identifier, and determining a confidence level of the second text.

16. The electronic device according to claim 15, wherein the determining the text to be displayed in the target text based on the semantic analysis result and the location identifier comprises:
determining the text to be displayed among the first text and the second text according to the confidence level of the first text and the confidence level of the second text,
wherein in response to the confidence level of the first text being higher than the confidence level of the second text, the first text is determined as the text to be displayed; in response to the confidence level of the second text being higher than the confidence level of the first text, the second text is determined as the text to be displayed.

17. The electronic device according to claim 11, wherein the determining the rendering scheme corresponding to the text to be displayed comprises:
performing semantic analysis on the target text to obtain a semantic analysis result; and
obtaining the rendering scheme corresponding to the text to be displayed based on the semantic analysis result.

18. The electronic device according to claim 17, wherein the obtaining the rendering scheme corresponding to the text to be displayed based on the semantic analysis result comprises:
determining the rendering scheme corresponding to the text to be displayed based on the semantic analysis result and feature information of the first image; wherein the feature information of the first image comprises at least one of a size of the first image, a color of the first image, and a content of the first image.

19. The electronic device according to claim 12, wherein the method further comprises:
recognizing characters in the target image to obtain a first character recognition result;
outputting the target image in response to the first character recognition result being consistent with the text to be displayed.

20. A computer-readable storage medium with instructions stored thereon, wherein the instructions cause at least one processor to perform an image generating method, and the method comprises:
obtaining a target text; the target text comprising description information of a background image and a text to be displayed;
determining the text to be displayed based on the target text;
generating a first image based on the target text; and
compositing the text to be displayed with the first image to obtain a target image, and the target image comprising the text to be displayed.
